(19) United States
(12) Patent Application Publication
(10) Pub. No.: US 2013/0069827 A1
(43) Pub. Date: Mar. 21, 2013

(54) NAVIGATION DEVICE AND SYSTEM

(71) Applicant: JIAN-HUI LI, Shenzhen City (CN)

(72) Inventor: JIAN-HUI LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/584,949

(22) Filed: Aug. 14, 2012

(30) Foreign Application Priority Data
Sep. 19, 2011 (CN) 201110277571.6

(51) Int. Cl. G01S 5/04

(52) U.S. Cl. 342/451

(57) ABSTRACT

A navigation device communicating with a plurality of ranging emitters located at fixed positions of a specific location includes a receiver communicating with the ranging emitters, a storage storing identification numbers of the ranging emitters, a display screen for displaying layout of the location, and a processor electronically connected to the receiver, the storage, and the display screen. The receiver receives identification number signals from the ranging emitters at a fixed frequency, and sends the identification number signals to the processor. The processor receives the identification number signals, identifies the ranging emitters according to the identification numbers stored in the storage, calculates a distance S between one ranging emitter and the navigation device, and sends a calculated location signal to the display screen. The display screen displays real-time location of the navigation device according to the calculated location signal.

### BACKGROUND

1. Technical field

The disclosure generally relates to navigation devices and systems, and particularly to a navigation device and system used in specific locations such as shopping malls, supermarkets, museums etc.

2. Description of the Related Art

In a shopping mall, if people are unfamiliar with the layout, they may waste time looking for what they want.

### BRIEF DESCRIPTION OF THE DRAWINGS

Many aspects of an exemplary navigation device and system can be better understood with reference to the following drawings. The components in the drawings are not necessarily drawn to scale, the emphasis instead being placed upon clearly illustrating the principles of the exemplary navigation device and system. Moreover, in the drawings, like reference numerals designate corresponding parts throughout the several views. Wherever possible, the same reference numbers are used throughout the drawings to refer to the same or like elements of an embodiment.

FIG. 1 is a schematic view of a navigation device according to an exemplary embodiment.

FIG. 2 is a schematic view showing layout of a navigation system according to an exemplary embodiment.

FIG. 3 is a block diagram of the navigation device shown in FIG. 1.

FIG. 4 is a schematic view illustrating a location principle of the navigation device shown in FIG. 2.

### DETAILED DESCRIPTION

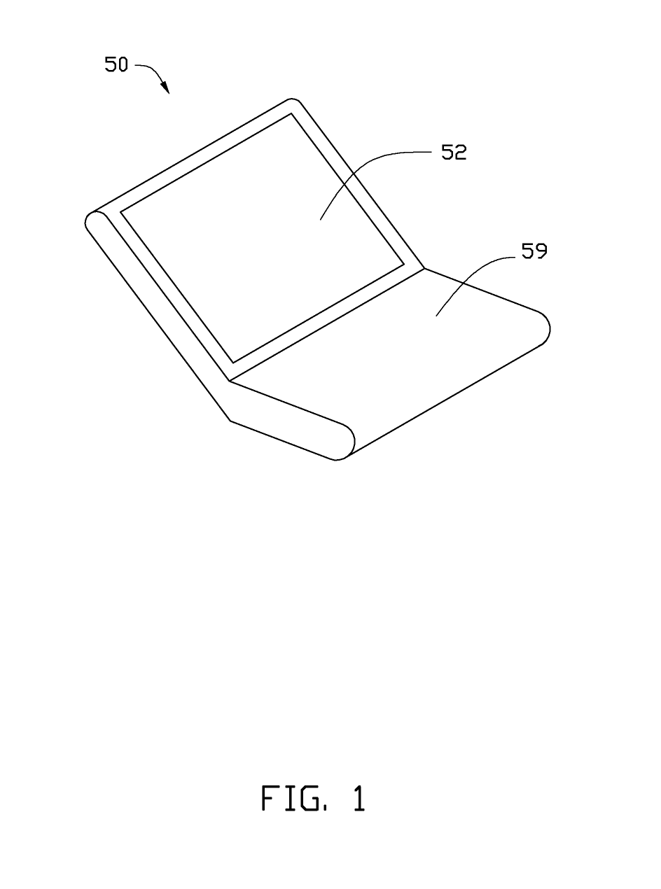

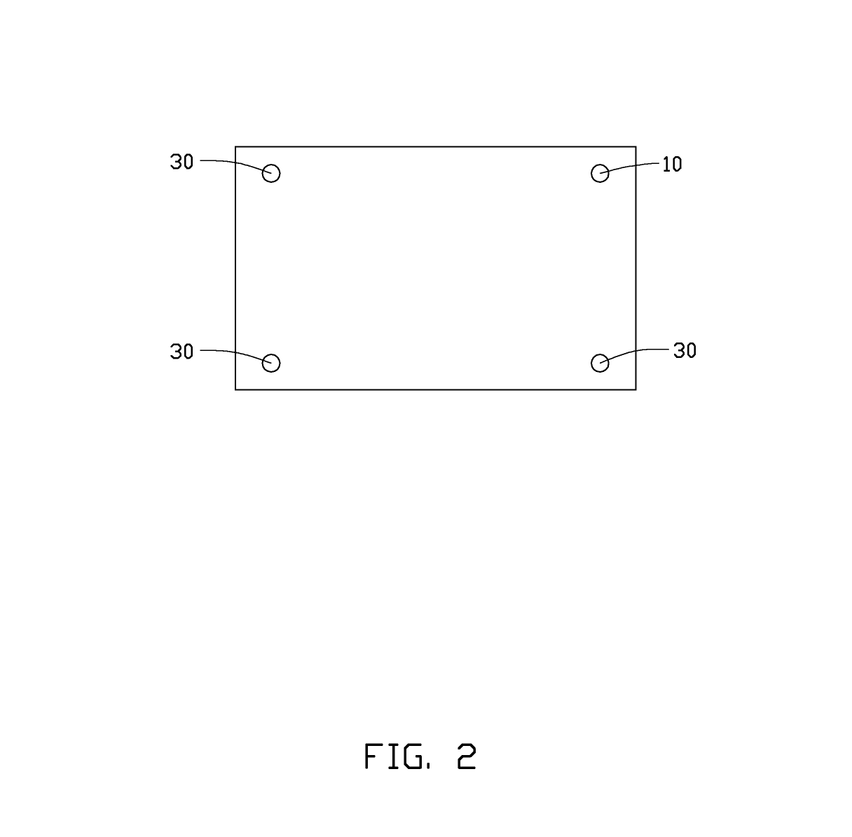

Referring to FIG. 1 and FIG. 2, a navigation system according to an exemplary embodiment is shown. The navigation system can be used in specific locations such as shopping malls, supermarkets, museums, etc. In this exemplary embodiment, the navigation system is employed in shopping malls.

The navigation system includes a synchronous emitter 10, at least three ranging emitters 30, and a navigation device 50. The synchronous emitter 10 and the ranging emitters 30 are located at fixed positions of the shopping mall. In this exemplary embodiment, the synchronous emitter 10 and the ranging emitters 30 are spaced from each other and are located at a periphery of the shopping mall. The navigation device 50 can be located on a shopping cart.

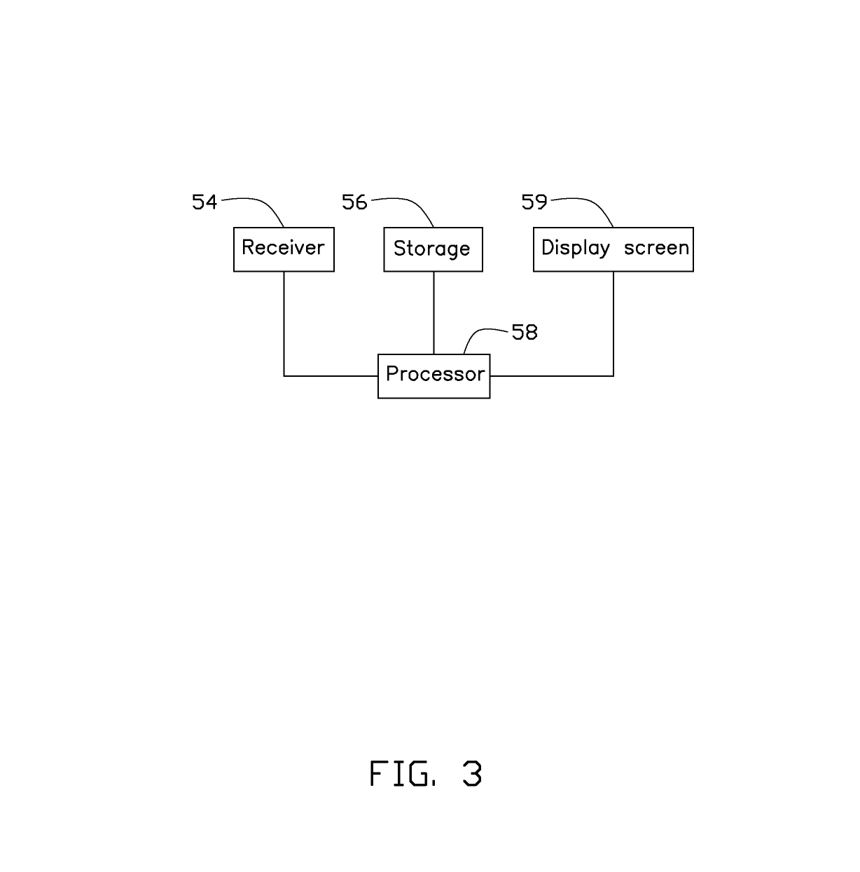

Also referring to FIG. 3, the navigation device 50 includes a body 52, a receiver 54, a storage 56, a processor 58, and a display screen 59. The receiver 54, the storage 56, and the processor 58 are located in the body 52. The display screen 59 is located on the body 52.

The synchronous emitter 10 wirelessly sends a wireless synchronizing clock signal to the ranging emitters 30 and the receiver 54.

Each ranging emitter 30 includes an identification number and wirelessly sends a identification number signal to the receiver 54 at a fixed frequency. In this exemplary embodiment, a communication frequency among the synchronous emitter 10, the ranging emitters 30, and the navigation device 50 is 1000 MHz or greater. A wavelength of a signal having a communication frequency of 1000 MHz is 0.38 meters. This is considered a short wavelength and the shorter the wavelength of the signals used, the stronger the linear transmission characteristic of the signals, the better the ranging accuracy, and the better the positioning accuracy of the navigation system.

The storage 56 stores the identification numbers of the ranging emitters 30 and layout information of the shopping mall. In this exemplary embodiment, the layout information of the shopping mall also includes location information of commodities and rest-room facilities. The receiver 54, the storage 56, and the display screen 59 are electronically connected to the processor 58.

The working process of the navigation system is as follows:

The navigation device 50 is started. The processor 58 reads the layout information of the shopping mall from the storage 56 and sends the layout information of the shopping mall to the display screen 59. The display screen 59 displays the layout of the shopping mall. The synchronous emitter 10 wirelessly sends a synchronizing clock signal to the ranging emitters 30 and the receiver 54. Each ranging emitter 30 wirelessly sends an identification number signal to the receiver 54 at a fixed frequency. The receiver 54 sends the identification number signals to the processor 58. The processor 58 receives the identification number signals, and identifies the ranging emitters 30 according to the identification numbers stored in the storage 56.

Transmission time Tr of the identification number signal between the ranging emitter 30 and the receiver 54 is calculated by the processor 58. Specifically, the synchronous emitter 10 sends a synchronizing clock signal to the ranging emitter 30 and the receiver 54 at time T1, and the synchronizing clock signal is received by the ranging emitter 30 after a period of time T2. Because of the fixed location of the synchronous emitter 10 and the ranging emitter 30, T2 is constant. The ranging emitter 30 sends an identification number signal to the receiver 54, and the identification number signal is received by the receiver 54 at time T3. An equation for the transmission time Tr is Tr=T3−(T1+T2).

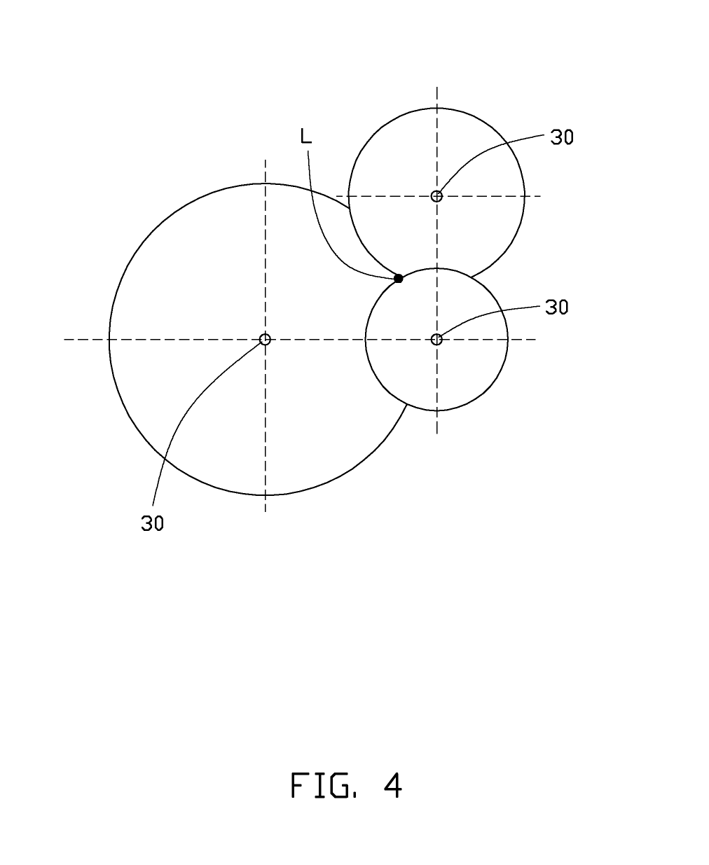

An equation for a distance S between one ranging emitter 30 and the navigation device 50 is S=Tr×V where V is velocity of radio waves, and the distance S is calculated by the processor 58. The navigation device 50 can be considered to be located on a circle, and the center of the circle is the ranging emitter 30, and a radius of the circle is S. Referring to FIG. 4, three circles intersecting with each other define a unique point L which is a real-time location of the navigation device 50. And then, the processor 58 sends a calculated location signal to the display screen 59, and the display screen 59 displays the real-time location of the navigation device 50 according to the calculated location signal. According to the real-time location of the navigation device 50 and the layout information of the shopping mall displayed on the display screen 59, people can quickly find a best path to where they want to go and any products they wish to find.

The navigation system makes it easy for users to navigate unfamiliar locations.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A navigation device communicating with a plurality of ranging emitters located at fixed positions of a specific location, the navigation device comprising:
a receiver wirelessly communicating with the plurality of ranging emitters;
a storage storing identification numbers of the plurality of ranging emitters;
a display screen for displaying layout of the specific location; and
a processor electronically connected to the receiver, the storage and the display screen;
wherein the receiver wirelessly receives identification number signals from the plurality of ranging emitters at a fixed frequency, and sends the identification number signals to the processor; the processor receives the identification number signals, identifies the plurality of ranging emitters according to the identification numbers stored in the storage, calculates a distance S between one ranging emitter and the navigation device, and sends a calculated location signal to the display screen; the display screen displays real-time location of the navigation device according to the calculated location signal.

2. The navigation device as claimed in claim 1, wherein the processor calculates a transmission time Tr of the identification number signal between the ranging emitter and the receiver, and calculates the distance S based on: S=Tr times V where V is velocity of radio waves.

3. The navigation device as claimed in claim 2, wherein the receiver further communicates with a synchronous emitter, and the receiver and the plurality of ranging emitters receives a synchronizing clock signal from the synchronous emitter.

4. The navigation device as claimed in claim 3, wherein the transmission time Tr is calculated based on: Tr=T3−(T1+T2) where T1 is a sending time of the synchronizing clock signal, T2 is a transmission period of the synchronizing clock signal transmitting from the synchronous emitter to the ranging emitter, and T3 is a receipt time the synchronizing clock signal received by the receiver.

5. The navigation device as claimed in claim 4, wherein the storage further stores layout information of the specific location; the processor reads the layout information from the storage and sends the layout information to the display screen for displaying.

6. The navigation device as claimed in claim 5, wherein further comprises a body; the receiver, the storage, and the processor are located in the body; the display screen is located on the body.

7. The navigation device as claimed in claim 3, wherein a communication frequency among the synchronous emitter, the plurality of ranging emitters and the navigation device is 1000 MHz or greater.

8. A navigation system used in a specific location, comprising:
a navigation device comprising a receiver, a storage, a display screen, and a processor, the receiver, the storage and the display screen are electronically connected to the processor; and
a plurality of ranging emitters communicating with the receiver located at fixed positions of the specific location;
wherein the storage stores identification numbers of the plurality of ranging emitters; the display screen displays layout of the specific location; the receiver wirelessly receives identification number signals from the plurality of ranging emitters at a fixed frequency, and sends the identification number signals to the processor; the processor receives the identification number signals, identifies the plurality of ranging emitters according to the identification numbers stored in the storage, calculates a distance S between one ranging emitter and the navigation device, and sends a calculated location signal to the display screen; the display screen displays real-time location of the navigation device according to the calculated location signal.

9. The navigation system as claimed in claim 8, wherein the processor calculates a transmission time Tr of the identification number signal between the ranging emitter and the receiver, and calculates the distance S based on: S=Tr times V where V is velocity of radio waves.

10. The navigation system as claimed in claim 9, wherein the receiver further communicates with a synchronous emitter, and the receiver and the plurality of ranging emitters receives a synchronizing clock signal from the synchronous emitter.

11. The navigation system as claimed in claim 10, wherein the transmission time Tr is calculated based on: Tr=T3−(T1+T2) where T1 is a sending time of the synchronizing clock signal, T2 is a transmission period of the synchronizing clock signal transmitting from the synchronous emitter to the ranging emitter, and T3 is a receipt time the synchronizing clock signal received by the receiver.

12. The navigation system as claimed in claim 11, wherein the storage further stores layout information of the specific location; the processor reads the layout information from the storage and sends the layout information to the display screen for displaying.

13. The navigation system as claimed in claim 12, wherein further comprises a body, the receiver, the storage, and the processor are located in the body; the display screen is located on the body.

14. The navigation system as claimed in claim 10, wherein a communication frequency among the synchronous emitter, the plurality of ranging emitters and the navigation device is 1000 MHz or greater.
